(19) United States
(12) Patent Application Publication
(10) Pub. No.: US 2012/0063795 A1
(43) Pub. Date: Mar. 15, 2012

(54) IMAGE FORMING APPARATUS

(75) Inventor: Kazuhiro Funatani, Mishima-shi (JP)

(73) Assignee: CANON KABUSHIKI KAISHA, Tokyo (JP)

(21) Appl. No.: 13/223,872

(22) Filed: Sep. 1, 2011

(30) Foreign Application Priority Data
Sep. 14, 2010 (JP) 2010-205984

(51) Int. Cl. G03G 15/00; G03G 15/16

(52) U.S. Cl. 399/44; 399/66

(57) ABSTRACT

The image forming apparatus calculates a total length of a blank region in which toner is not moved with respect to the length of the recording material in a direction perpendicular to the direction of conveying the recording material P. When the toner image on the intermediate transfer belt is transferred to the recording material P in the secondary transfer unit and the total length of the blank region without the toner image is greater than a preset first reference value, a voltage supplied to a secondary transfer roller is corrected such that the voltage has the same polarity as the preset reference voltage according to the first reference value and the absolute value is greater than the absolute value of the reference voltage.

### BACKGROUND OF THE INVENTION

1. Field of the Invention

The present invention relates to an image forming apparatus such as a copy machine and a printer having a function of forming an image on a recording material such as a sheet.

2. Description of the Related Art

In recent years, electrophotographic image forming apparatuses have advanced to have high speeds, high functionality, and color capability, and various printers and copy machines are available on the market. As the electrophotographic system for a color image forming apparatus, a tandem system has been proposed because a color image can be formed at high speeds. The electrophotographic system for the color image forming apparatus is divided into a direct transfer system and an intermediate transfer system. In recent years, from the point of view of high functionality of the image forming apparatus, diversity of sheets (media) is required in terms of the size, the thickness (basic weight), the surface property (for example, sheet of rough surface), and the like of the recording media.

Meanwhile, the environment for the image forming apparatus is not limited to a conventional air conditioned office. For example, with the spread of SOHO (small office home office), an excellent output image is desired to be obtained even in an individual office, a home office, and other various environment.

Thus, from the point of view of the media flexibility, the use environment, and the like, the image forming apparatus is required to have higher and higher performance.

Unfortunately, the recording material, the intermediate transfer belt for use in the intermediate transfer member system, and the transfer conveyor belt for use in the direct transfer system have an unstable resistance value depending on the environment (temperature and humidity). Thus, it may be difficult to stably output good images due to a variation of the environment of the apparatus and the type of the recording material.

Examples of the intermediate transfer belt and the transfer conveyor belt include a film-like member made by adding an electron-conductive agent or an ion conductive agent such as carbon black for adjusting the electrical resistance to a resin. The intermediate transfer belt and the transfer conveyor belt to which the electron-conductive agent is added may have an uneven electrical resistance value due to distribution failure at manufacturing. The intermediate transfer belt and the transfer conveyor belt to which the ion conductive agent is added may have an environmental variation in electrical resistance value due to the variation in temperature and moisture content depending on the environmental conditions.

Meanwhile, examples of the recording material includes paper consisting mainly of a highly hygroscopic cellulose whose electrical resistance value greatly differs depending on the hygroscopic state. For example, in a high temperature and humidity environment in which paper absorbs moisture (H/H environment (30° C./80% RH)), the electrical resistance of the paper reduces up to about 10⁶ Ωcm. Meanwhile, in a low temperature and humidity environment (L/L environment (15° C./10% RH)), the electrical resistance of the paper increases up to about 10¹² Ωcm.

When an attempt is made to transfer a toner image to the intermediate transfer belt, the transfer conveyor belt, and the recording material each having a changing electrical resistance, a transfer failure may occur because a transfer current is difficult to flow while the electrical resistance is high. Conversely, while the electrical resistance is low, the transfer current flows excessively, the toner image transferred to the recording material from the photosensitive member or the intermediate transfer belt is susceptible to polarity reversal receiving opposite charge due to discharge. Then, the toner of opposite charging polarity is reversely transferred to the photosensitive member or the intermediate transfer belt, thus reducing the transfer efficiency.

In view of this, Japanese Patent Application Laid-Open No. H08-190285 discloses a method of changing the settings of the transfer voltage according to the basic weight and the environmental conditions of the recording material. Specifically, the method performs constant current control when the nip portion is in a non-image forming area; detects a voltage occurring when the nip portion is in a non-image forming area and when no sheet is fed and a voltage occurring when the nip portion is in a non-image forming area and when a sheet is fed; and based on each of the voltages, determines the transfer voltage when the nip portion is in an image forming area.

Unfortunately, the Japanese Patent Application Laid-Open No. H08-190285 may lead to a concern that the following problem will occur.

The problem is such that when in a high humidity environment, a sheet with reduced electrical resistance is used to print an image with a large blank region without toner in a sheet width direction, namely, in a direction perpendicular to the direction of conveying the sheet, a transfer failure occurs due to a shortage of transfer current flowing through a toner portion. Note that in the following description, the blank region refers to a portion without toner of the region in the width direction perpendicular to the direction of conveying the recording material.

In order to solve the above problem, when sufficient transfer current is supplied so as to prevent a transfer failure from occurring in an image with a large blank region, excessive transfer current occurs in an image with a small blank region in a longitudinal direction, leading to another image failure such as reverse transfer due to toner charging polarity reversal.

### SUMMARY OF THE INVENTION

In view of this, a purpose of the invention is to provide an image forming apparatus transferring a toner image formed on an image bearing member to a recording material in a nip portion with the transfer member therebetween in a better manner regardless of the size of a blank region without a toner image. Another purpose of the present invention is to provide an image forming apparatus including an image bearing member on which a toner image is formed, a transfer member that forms a nip portion with the image bearing member therebetween, wherein the transfer member transfers the toner image formed on the image bearing member to a recording material, a calculation unit that calculates a total length of a blank region in which toner is not moved with respect to the length of the recording material in a direction perpendicular to the direction of conveying the recording material before the toner image on the image bearing member is transferred to the recording material in the nip portion, a voltage supply unit supplying a voltage to the transfer member so as to transfer the toner image to the recording material, and a control unit that controls the voltage supply unit, wherein in a case where the total length of the blank region calculated by the calculation unit is greater than a preset first reference value, the control unit corrects a voltage supplied from the voltage supply unit to the transfer member so that the voltage has the same polarity as a preset reference voltage corresponding to the first reference value and an absolute value thereof is greater than the absolute value of the reference voltage.

A further purpose of the present invention is to provide an image forming apparatus including an image bearing member on which a toner image is formed, a transfer member that forms a nip portion with the image bearing member therebetween, wherein the transfer member transfers the toner image formed on the image bearing member to a recording material, a calculation unit that calculates a total length of a blank region in which toner is not moved with respect to the length in a direction perpendicular to the direction of conveying the recording material, a current supply unit that supplies a current to the transfer member so as to transfer the toner image to the recording material, and a control unit that performs constant current control on a current supplied from the current supply unit to the transfer member, wherein in a case where the total length of the blank region calculated by the calculation unit is greater than a preset first reference value, the control unit corrects a constant current control value supplied from the current supply unit to the transfer member such that the current has the same polarity as a preset reference current value corresponding to the first reference value and an absolute value thereof is greater than the absolute value of the reference current value.

Further features of the present invention will become apparent from the following description of exemplary embodiments with reference to the attached drawings.

### BRIEF DESCRIPTION OF THE DRAWINGS

FIG. 1 is a sectional view illustrating a schematic configuration of an image forming apparatus according to an embodiment.

FIG. 2 illustrates a secondary transfer high-voltage power supply.

FIG. 3 is a schematic drawing of a secondary transfer unit.

FIG. 4 is an equivalent circuit diagram of the secondary transfer unit illustrated in FIG. 3.

FIGS. 5A and 5B are equivalent circuits in the case of increased blank region width.

FIG. 6 illustrates a method of calculating the blank region width.

FIG. 7A illustrates an image pattern (toner portion width).

FIG. 7B corresponds to the image pattern illustrated in FIG. 7A and illustrates a relation to a secondary transfer bias as a correction control voltage.

FIG. 8 illustrates a sheet resistance detection position.

FIG. 9 illustrates a method of measuring a development current.

### DESCRIPTION OF THE EMBODIMENTS

Preferred embodiments of the present invention will now be described in detail in accordance with the accompanying drawings.

The preferred embodiments of the present invention will be described in conjunction with the accompanying drawings.

### Embodiment 1

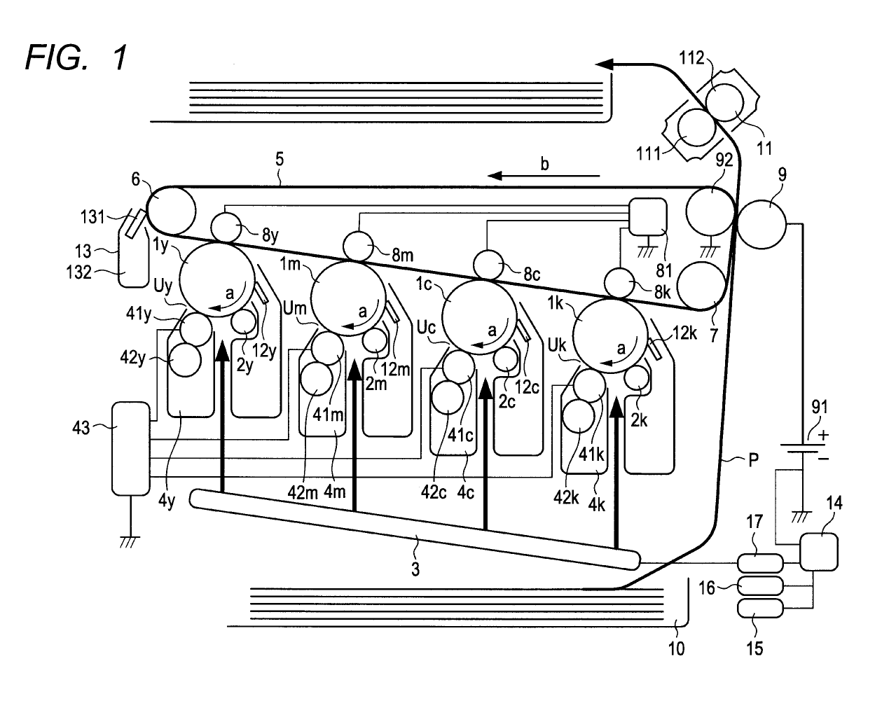

FIG. 1 is a sectional view illustrating a schematic configuration of an image forming apparatus according to an embodiment 1 of the present invention. The present embodiment will describe an electrophotographic tandem color (multi-color) laser printer as the image forming apparatus. Hereinafter, the configuration of the image forming apparatus will be described in the order of the image forming process.

As illustrated in FIG. 1, individual image forming units Uy, Um, Uc, and Uk for respective toners: yellow, magenta, cyan, and black are arranged along a flat surface portion of an intermediate transfer member (intermediate transfer belt, hereinafter referred to as an intermediate transfer belt) 5 as an image bearing member. Each image forming unit has the same basic configuration and thus the following description of the image forming units will focus on only the image forming unit Uy for yellow.

In FIG. 1, the image forming unit Uy for yellow includes a cylindrical photosensitive member 1y which is rotatably driven in a direction indicated by an arrow <a> at a peripheral speed of 100 mm/sec. A charging roller 2y as a charging device is arranged on a surface of the photosensitive member 1y so as to be press-contacted thereto. The charging roller 2y rotates following the rotation of the photosensitive member 1y. When an AC or DC voltage is applied from an unillustrated charging high-voltage power supply during rotation, the charging roller 2y charges the surface of the photosensitive member 1y to a desired potential.

Then, the photosensitive member 1y is exposed by an image exposure unit 3 as a latent image forming unit according to the recorded image information. The exposure is performed by a laser beam scanner, an LED, and the like.

A one-component non-magnetic contact development device 4y as a development unit includes a developing roller 41y conveying developer (toner) on a surface of the photosensitive member 1y; and a toner supply roller 42y reapplying the toner to a surface of the developing roller 41y.

The developing roller 41y whose surface is uniformly coated with toner is lightly press-contacted to the photosensitive member 1y and rotates with a difference in speed in a forward direction. When a predetermined DC voltage is applied from a development high-voltage power supply 43, a latent image on the photosensitive member 1y is visualized as a toner image.

The developing roller 41y is in contact with a toner supply roller 42y supplying toner to the developing roller 41y. Note that the present embodiment uses the one-component non-magnetic contact development method, but a two-component non-magnetic contact development or non-contact two-component non-magnetic non-contact development method may be used. Note also that the developer of the present embodiment is a polymerized toner made by a polymerization method. In the present embodiment, the photosensitive member 1y is configured to be detachably attached to the developing roller 41y. Specifically, the developing roller 41y abuts against the photosensitive member 1y only during image formation.

The toner image on the photosensitive member 1y visualized by the developing roller 41y is conveyed to a primary transfer unit formed between the intermediate transfer belt 5 and the photosensitive member 1y following the rotation of the photosensitive member 1y. The intermediate transfer belt 5 is driven in a direction indicated by an arrow <b> in contact with the photosensitive member 1y.

A primary transfer roller 8y as a primary transfer member is arranged so as to press the photosensitive member 1y with the intermediate transfer belt 5 sandwiched therebetween. When a primary transfer voltage is applied to the primary transfer roller 8y from a primary transfer high-voltage power supply 81, a transfer field is formed in a primary transfer unit. The toner image reaching the primary transfer unit is transferred to a surface of the intermediate transfer belt 5 by the action of the transfer field.

The charging state of the photosensitive member 1y after the primary transfer is unstable depending on the presence or absence of the toner image and the influence of the primary transfer voltage. In light of this, the present embodiment provides an unillustrated charging exposure unit using an LED and the like to irradiate the photosensitive member 1y after the primary transfer so as to stabilize the charging state of the photosensitive member 1y for uniform charging.

The primary transfer roller 8y of the present embodiment is made by forming an EPDM rubber layer around a core bar into a roller shape. The EPDM rubber layer is made by dispersing and foaming conductive carbon particles so as to have a volume resistivity of 10⁵ Ω·cm or less. The voltage from the primary transfer high-voltage power supply 81 is applied to the core bar. Note that the transfer roller of the present embodiment has a roller shape, but may have a sheet shape, a blade shape, or a brush shape.

The intermediate transfer belt 5 of the present embodiment has a volume resistivity of 10⁷ Ω·cm or less. The belt may be a single-layer belt made by dispersing conductive particles in a resin or rubber material and adjusting the resistance value. Alternatively, the belt may be a multi-layer belt made by coating a fluorocarbon resin such as PTFE, PFA, and ETFE to a thickness of several tens of μm on an upper surface of the resin or rubber belt having a resistance value of 10⁴Ω or less for improving demoldability. Here, PTFE refers to polytetrafluoroethylene, PFA refers to tetrafluoroethylene-perfluoroalkylvinylether copolymer, and ETFE refers to ethylene-tetrafluoro copolymer resin.

The intermediate transfer belt 5 is laid across in a tensioned state between a drive roller 6, a support roller 7, and a secondary transfer counter roller 92 to be driven as an intermediate transfer unit. Respective toner images formed by the other image forming units Um, Uc, and Uk in the same manner as by the image forming unit Uy are sequentially overlapped on the intermediate transfer belt 5 to form a full color toner image.

Here, an electrically floating voltage or a high voltage similar to the primary transfer voltage is applied to the drive roller 6 and the support roller 7. Further, the secondary transfer counter roller 92 is adjusted to have a resistance value of 10⁶Ω or less and is grounded.

When the full color toner image on the intermediate transfer belt 5 (image bearing member) reaches a secondary transfer unit as a nip portion formed between a secondary transfer roller (secondary transfer unit) 9 as a transfer member and the intermediate transfer belt 5, a recording material P is accordingly fed from a feed unit 10. At the timing when the recording material P reaches the secondary transfer unit, a predetermined voltage is applied to the secondary transfer roller 9 from a secondary transfer high-voltage power supply 91 as a voltage supply unit to transfer the toner image to the recording material P pinched and conveyed in the secondary transfer unit.

Like the primary transfer roller 8, the secondary transfer roller 9 is also made by forming an EPDM rubber layer 9b around a core bar 9a into a roller shape. The EPDM rubber layer 9b is adjusted to have a volume resistivity of 10⁷ to 10¹³ Ω·cm. Like the primary transfer roller 8, the voltage from the secondary transfer high-voltage power supply 91 is applied to the core bar 9a.

The action of the secondary transfer voltage causes a secondary transfer current to flow along the path from the secondary transfer roller 9, the recording material P, the intermediate transfer belt 5, to the secondary transfer counter roller 92 to form an electric field required for the secondary transfer.

The recording material P to which the full color toner image is transferred is separated from the intermediate transfer belt 5 by the curvature of the secondary transfer counter roller 92 and is conveyed to a fixing device 11 with the toner image being placed on the recording material P. The action of heat and pressure by the fixing device 11 causes the toner image on the recording material P to be fixed to the recording material P. Here, the fixing device 11 includes a fixing sleeve 111 and a pressure roller 112.

Meanwhile, the transfer toner remaining on the photosensitive member 1y after the primary transfer is cleaned by a photosensitive member cleaner 12y. The transfer toner remaining on the intermediate transfer member after the secondary transfer is removed by a cleaning apparatus 13. Here, the cleaning apparatus 13 includes a cleaning blade 131 and a waste toner container 132.

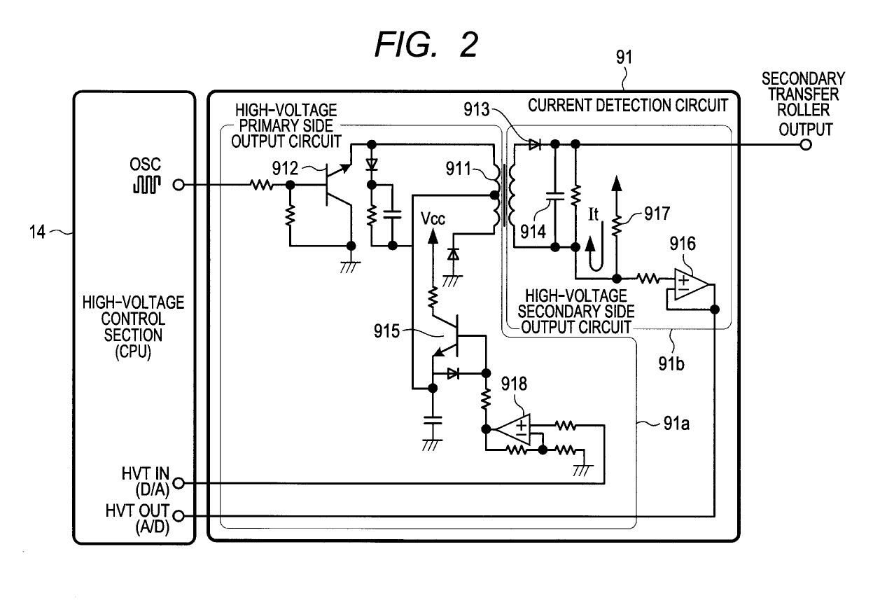

Hereinafter, the control of the secondary transfer high-voltage power supply 91 of the present embodiment will be described. The present embodiment uses the constant voltage control as the control of the secondary transfer high-voltage power supply 91. Here, referring to FIG. 2, the secondary transfer high-voltage power supply 91 applying a high voltage to the secondary transfer roller 9 will be described.

The secondary transfer high-voltage power supply roughly includes a high-voltage primary-side output circuit 91a and a high-voltage secondary-side output circuit 91b having a current detection circuit as an output current detection unit.

A positive voltage is applied to the secondary transfer roller 9 from an inverter transformer 911. The inverter transformer 911 is driven by a pulse signal OSC from a high-voltage control unit (CPU) 14 driven by a power supply voltage V [V] through a transistor 912 in the high-voltage primary-side output circuit 91a. The pulse signal OSC is rectified by a diode 913 and a capacitor 914 in the high-voltage secondary-side output circuit 91b of an inverter transformer 911 and then is applied to the secondary transfer roller 9.

In the high-voltage control unit 14, HVTIN refers to a D/A output of a DC level signal and HVTOUT refers to an A/D input of a high-voltage output.

The DC level of a secondary transfer output is proportional to an emitter voltage of a transistor 915. The HVTIN output from the high-voltage control unit 14 is amplified by an operational amplifier 918 and input to a base of the transistor 915. Accordingly, a transfer output voltage increases with an increase in HVTIN.

The output current at this time can be detected by an operational amplifier 916 by checking for a voltage drop in a resistor 917 (r [Ω]).

The high-voltage control unit 14 calculates an output current It from an output (HVTOUT) from the operational amplifier 916 by the expression: It [A]=(V−HVTOUT) [V]/r [Ω].

Based on the value of the It [A], the high-voltage control unit 14 controls the value of the HVTIN(D/A). Note that the primary transfer high-voltage power supply 81 and the development high-voltage power supply 43 have the same configuration as that of the secondary transfer high-voltage power supply 91.

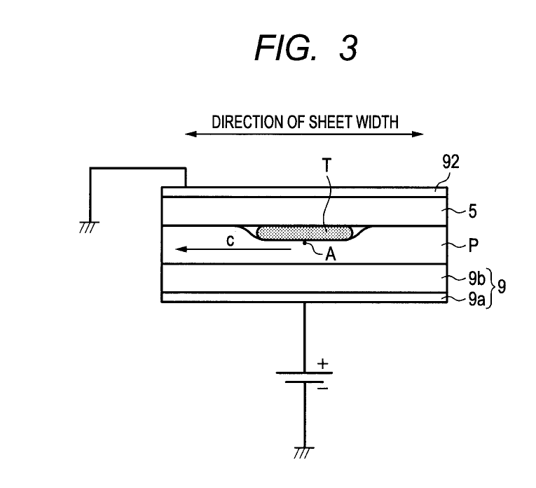

Now, the characteristic units in the present embodiment will be described. FIG. 3 is a schematic drawing of the secondary transfer unit. When a hygroscopic sheet is used as the recording material in a high humidity environment, the electrical resistance of the sheet is reduced. Accordingly, a transfer current tends to flow in a direction indicated by an arrow <c> in FIG. 3, namely, from the position of a toner layer T to a blank region without toner. As a result, the potential at a position A (hereinafter referred to as the position A) illustrated in FIG. 3 is lowered. Thus, it is concerned that a potential difference required for toner transfer cannot be obtained and a transfer failure occurs. Further, if there is a large blank region without toner, the potential at the position A is further lowered and thus it is concerned that the transfer failure becomes further remarkable.

Meanwhile, in the case in which the transfer voltage is increased to prevent an occurrence of a transfer failure occurring when the blank region width is increased, an excessive voltage occurs when an attempt is made to print an image with a small blank region width. In this case, it is concerned that reverse transfer due to toner charging polarity reversal causes a problem such as an image concentration reduction.

In view of this, it is an object of the present embodiment to prevent an occurrence of a transfer failure and a reverse transfer regardless of the size of the blank region.

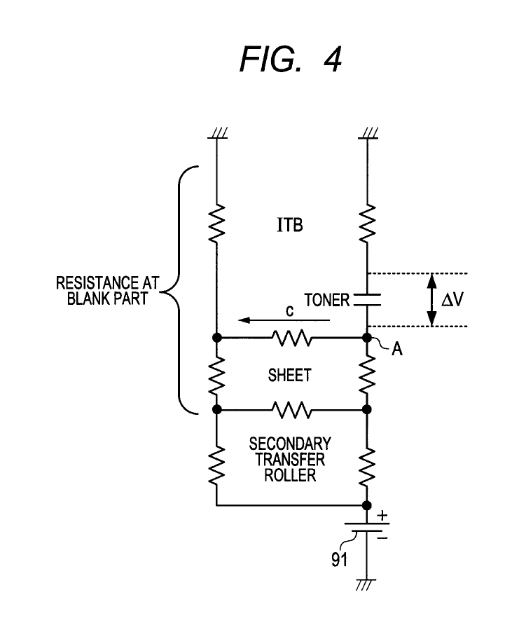

FIG. 4 is an equivalent circuit diagram of the secondary transfer unit illustrated in FIG. 3. Referring to FIG. 4, a further description will follow.

Transferring (moving) toner can be considered to be equivalent to charging a capacitor. In order to sufficiently move toner, a voltage ΔV according to the electric charge of the toner needs to be applied to the toner layer T. Thus, the potential at the position A illustrated in FIG. 4 needs to be a sufficient value. As understood from FIG. 4, the potential at the position A is determined by the value of the resistance of a portion of the sheet from the position of the toner layer T to the blank region without toner and the value of the current flowing therethrough.

Here, consider the case in which the blank region width in the sheet width direction changes. The sheet width direction refers to the width direction perpendicular to the direction of conveying the recording material of the surface (image surface) of the recording material to which the toner image is transferred. The blank region width refers to the total length of the blank region without a toner image with respect to the length in the width direction of the recording material. First, consider the relation between the change in blank region width and the voltage ΔV required to transfer toner. Since transferring (moving) toner can be considered to be equivalent to charging a capacitor, the following relation is established between the electric charge amount Q of the toner to be moved and the required voltage ΔV.

Q=C(capacitance of the toner layer)×ΔV

Obviously, a change in blank region width accordingly involves a change in toner portion width. For example, when the toner portion width changes to 1/m, the electric charge amount Q of the toner to be moved also changes to 1/m. Further, the cross-sectional area of the toner portion also changes to 1/m, and thus the capacitance C also changes to 1/m. Accordingly, the voltage ΔV for satisfying Q required to transfer (move) toner is constant regardless of the toner portion width.

Next, consider the relation between the change in blank region width and the voltage ΔV.

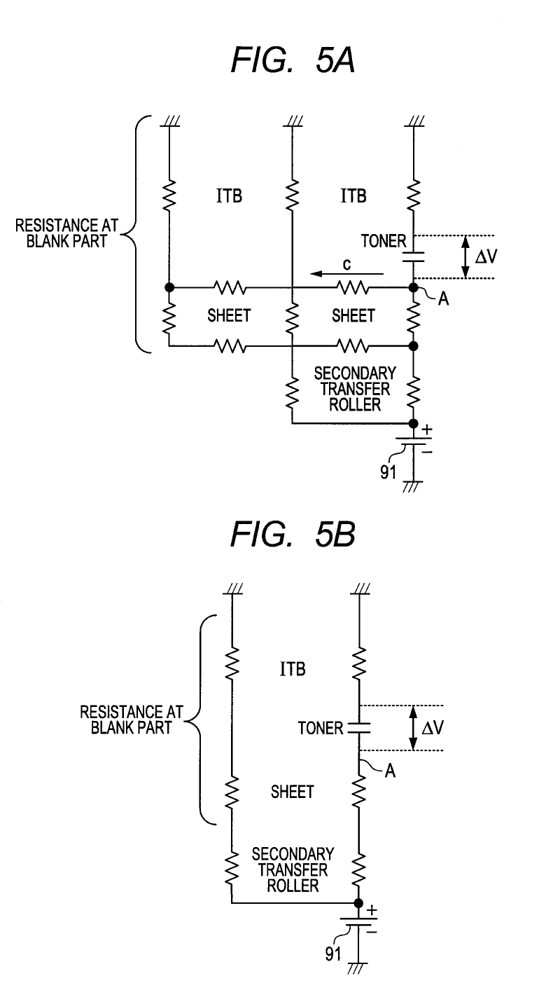

FIG. 5A is an equivalent circuit in the case of an increased blank region width. An increase in blank region width is equivalent to an increase in cross-sectional area of the blank region. Use of the equivalent circuit reveals that as illustrated in FIG. 5A, the blank region corresponds to a parallel circuit, which means a reduction in electrical resistance of the blank region. Accordingly, when a conventionally well-known constant voltage control is performed, the divided voltage of the blank region reduces, thus causing a reduction in potential at the position A. Thus, the voltage ΔV reduces, leading to a concern that a transfer failure occurs. Further, when a conventionally well-known constant current control is performed, the amount of voltage drop due to the electrical resistance of the blank region reduces, thus causing a reduction in potential at the position A, namely, a reduction in the voltage ΔV, and leading to a concern that a transfer failure occurs.

Thus, when an increase in blank region width reduces the voltage ΔV, the amount Q of transferable (movable) electric charge becomes insufficient, leading to a concern that a transfer failure occurs. Meanwhile, in the case in which the transfer voltage is increased to prevent an occurrence of a transfer failure occurring when the blank region width increases, the voltage ΔV becomes excessively large when an attempt is made to print an image with a small blank region width. In this case, it is concerned that reverse transfer due to toner charging polarity reversal causes a problem such as an image concentration reduction. Accordingly, in order to solve both problems with the transfer failure and the reverse transfer at the same time, the secondary transfer voltage needs to be corrected according to the blank region width so as to prevent the voltage ΔV from being excessively large or small. Specifically, when the blank region width increases, a higher secondary transfer voltage needs to be applied.

In light of this, the present embodiment detects the blank region width and sequentially corrects the secondary transfer voltage (control voltage value) according to the change in blank region width so as to obtain a sufficient voltage ΔV, thereby preventing an occurrence of a transfer failure. More specifically, when the blank region width increases, a correction is made so as to increase the control voltage value, thereby suppressing a reduction in potential at the position A, namely, a reduction in the voltage ΔV, a reduction in ΔV, and thus preventing an occurrence of a transfer failure.

Now, the characteristics of the present embodiment will be described in detail. First, a sheet serving as a reference of the recording material is used and a control voltage value V_{ff} (reference voltage) is preliminarily set so as to obtain an optimal transferability when the blank region width is y₀ [mm] as a reference (first reference value and 10 mm in the present embodiment). The control voltage value V_{ff} is measured and set for each atmospheric environment and print mode and stored in a storage apparatus 15.

At printing, the high-voltage control unit 14 acquires atmospheric environment information from an atmospheric environment detection unit 16 and acquires the control voltage value V_{ff} according to the atmospheric environment and the print mode from the storage apparatus 15. The value V_{y} of a correction control voltage to be applied when the blank region has a width of y [mm] is obtained by multiplying the control voltage value V_{ff} by a coefficient Y(y) according to the blank region width y [mm] as the expression V_{y}=(y)×V_{ff}.

The present inventors have found, from our studies, that by setting the coefficient Y(y) according to the blank region width y [mm] as shown in Table 1, we have successfully obtained a sufficient voltage ΔV regardless of the blank region width and have prevented an occurrence of a transfer failure. The coefficient Y(y) is a value specific to a particular device depending on the configuration of the secondary transfer unit such as the resistance of the secondary transfer roller 9.

Here, in the case in which the toner image is transferred to the recording material in the secondary transfer unit, and the total length of the blank region without the toner image is larger than the first reference value (y₀ [mm]), the high-voltage control unit 14 corresponds to a correction unit correcting the secondary transfer voltage. More specifically, the high-voltage control unit 14 corrects the secondary transfer voltage such that the voltage has the same polarity as the preset control voltage value V_{ff} corresponding to the first reference value and the absolute value is greater than the absolute value of the control voltage value V_{ff}.

TABLE 1

| | | Blank region width y[mm] | | | | | |
|---|---|---|---|---|---|---|---|
| | | 10 | 20 | 30 | 50 | 100 | 150 |
| Coefficient | High | 1 | 1.7 | 2 | 2.7 | 4.3 | 6 |
| Y(y) | humidity | | | | | | |
| | environment | | | | | | |
| | Normal | 1 | 1 | 1 | 1 | 1 | 1 |
| | humidity | | | | | | |
| | environment | | | | | | |
| | Low humidity | 1 | 1 | 1 | 1 | 1 | 1 |
| | environment | | | | | | |

Note that sheet resistance is high in an environment other than the high humidity environment. Therefore, the transfer current is unlikely to flow in a direction indicated by an arrow <c> in FIG. 3, namely, from the position of a toner layer T to a blank region without toner. Use of the equivalent circuit reveals that as illustrated in FIG. 5B, the potential at the position A is unlikely to depend on the blank region resistance. Specifically, any change in blank region width does not reduce the voltage ΔV, and is unlikely to generate a transfer failure. Accordingly, in this case, control can be made with a constant control voltage value regardless of the blank region width, and thus the coefficient Y(y) is set to 1. Note that according to the present embodiment, based on an output from the atmospheric environment detection unit 16, when an absolute moisture amount in the atmospheric environment is equal to or greater than 16 [g/m³] (a preset humidity or higher), a high humidity environment is determined to make correction. Here, the atmospheric environment detection unit 16 corresponds to a humidity detection unit detecting a humidity in an environment in which the image forming apparatus is installed.

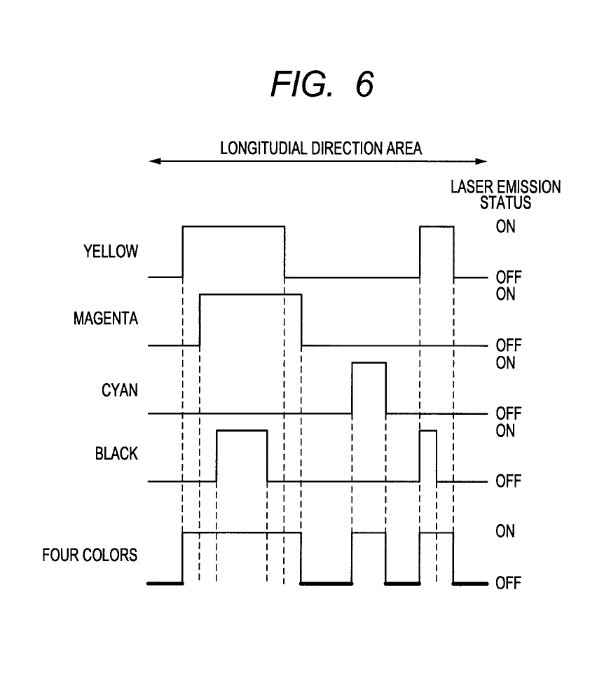

Now, referring to FIG. 6, a method of obtaining the blank region width y [mm] will be described.

The high-voltage control unit 14 acquires laser emitting state information about each color: yellow, magenta, cyan, and black in a longitudinal direction as illustrated in FIG. 6 from a controller 17. More specifically, the high-voltage control unit 14 acquires the laser emitting state information about magenta, cyan, and black based on a phase difference according to the distance from the primary transfer unit of yellow to the primary transfer unit of magenta, cyan, and black. In other word, the high-voltage control unit 14 acquires the laser emitting state information at the same position of the final output image. Here, the longitudinal direction refers to a rotational direction of the photosensitive member 1y (in a width direction of the recording material).

Based on the laser emitting state information about each color, the controller 17 obtains a non-laser emitting region, namely, the region of the blank region without toner about all colors indicated by “Four colors” in FIG. 6 and calculates the total thereof as the blank region width y [mm]. Here, the controller 17 has a calculation region calculating the total length of the blank region without a toner image with respect to the length in the width direction of the recording material P before the toner image is transferred to the recording material P in the secondary transfer unit.

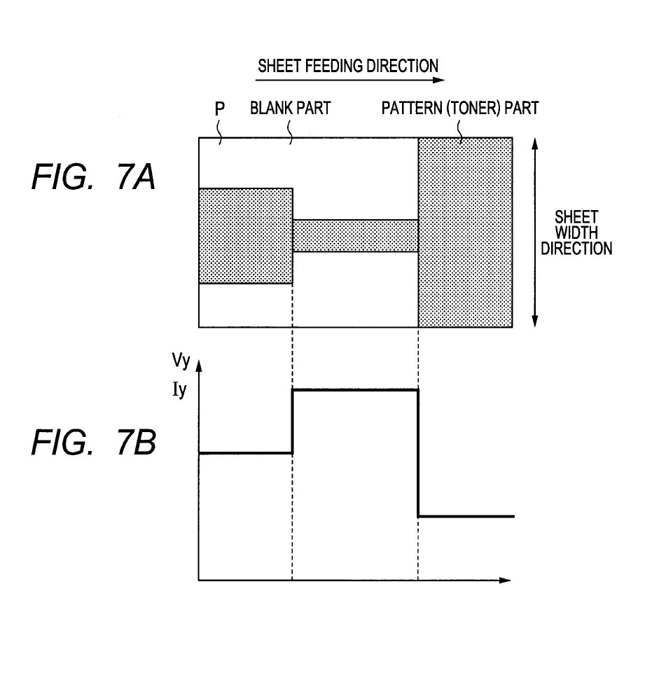

The high-voltage control unit 14 performs a process from acquiring the laser emitting state information to calculating the blank region width y [mm] for each line. The high-voltage control unit 14 calculates the correction control voltage value V_{y} to be applied when the blank region has a width of y [mm] as described above to sequentially correct the control voltage value V_{ff} to the correction control voltage value V_{y} as illustrated in FIG. 7B. FIG. 7A illustrates an image pattern (toner portion width) formed on the recording material P (sheet). FIG. 7B illustrates a relation between the image pattern (toner portion width) formed on the sheet and the correction control voltage value V_{y}.

The above configuration has proven that an appropriate voltage ΔV has been applied to the toner layer T regardless of a change in blank region width, thus preventing an occurrence of a transfer failure.

Meanwhile, when an image with a small blank region width is printed, an excessively large voltage ΔV is not applied to the toner layer T, thus preventing an occurrence of another image failure such as a reverse transfer due to toner charging polarity reversal.

Thus, the present embodiment always assures an excellent transfer regardless of the size of the blank region even when a hygroscopic sheet is used particularly in the high humidity environment.

Note that the present embodiment describes a configuration of obtaining the blank region width for each line, but is not limited to this. For example, a coefficient may be set for each type of an image depending on a text image containing a large amount of blank region and a graphic image containing a small amount of blank region to correct the secondary transfer current for each image.

Note also that the present embodiment describes a configuration of acquiring the control voltage value V_{ff} from the storage apparatus 15 based on the output from the atmospheric environment detection unit 16, but is not limited to this. For example, when no sheet is fed, the constant current control is made with a predetermined transfer current value, and based on the result, the control voltage is determined, which is a conventionally well-known configuration, the result of which may be used as the control voltage value V_{ff}. Further, based on the result of the constant current control, the atmospheric environment may be determined.

### Embodiment 2

Embodiment 2 describes that the electrical resistance of the recording material changes in embodiment 1. Note that the configuration and the operation of the image forming apparatus of the present embodiment are the same as those of embodiment 1. Thus, the same reference numerals or characters are assigned to the same components as those of embodiment 1, and the description is omitted.

Various types of sheets of varying characteristics are available on the market as the recording material. The electrical resistance is one of the characteristics. The electrical resistance of the sheet in the high humidity environment is generally different depending on the type of the sheet.

In light of this, it is an object of the present embodiment to prevent an occurrence of a transfer failure and an image failure such as a reverse transfer due to toner charging polarity reversal regardless of the change in sheet resistance.

As described in embodiment 1, in order to sufficiently move (transfer) toner, a voltage ΔV according to the electric charge of the toner needs to be applied to the toner layer T. The value of the voltage ΔV is determined by the potential at the position A illustrated FIGS. 3 and 4. The potential at the position A is determined by the value of the resistance of a portion of the sheet from the position of the toner layer T to the blank region without toner and the value of the current flowing therethrough. For example, consider the case in which when the sheet resistance is lower than that of the reference sheet used to set the voltage V_{ff}, control is made with the control voltage value obtained in embodiment 1. As understood from FIGS. 3 and 4, the potential at the position A is lower than the resistance of the reference sheet. Thus, a reduction in ΔV leads to a concern that a transfer failure occurs.

Thus, in this case, a larger secondary transfer voltage needs to be applied. Conversely, when the sheet resistance is higher than that of the reference sheet, the potential at the position A is higher than that of the reference sheet. Thus, an excessively large voltage ΔV leads to a concern that another image failure such as reverse transfer due to toner charging polarity reversal occurs. Therefore, in this case, a smaller secondary transfer voltage needs to be applied.

In light of this, the present embodiment not only corrects the control voltage value V_{ff} according to the change in blank region width as described in embodiment 1, but also detects the electrical resistance of the sheet and performs correction according to the detection results. More specifically, when the electrical resistance of the sheet is determined low, a correction is made so as to apply a larger secondary transfer voltage, thereby suppressing a reduction in potential at the position A, namely, a reduction in the voltage ΔV and thus preventing an occurrence of a transfer failure.

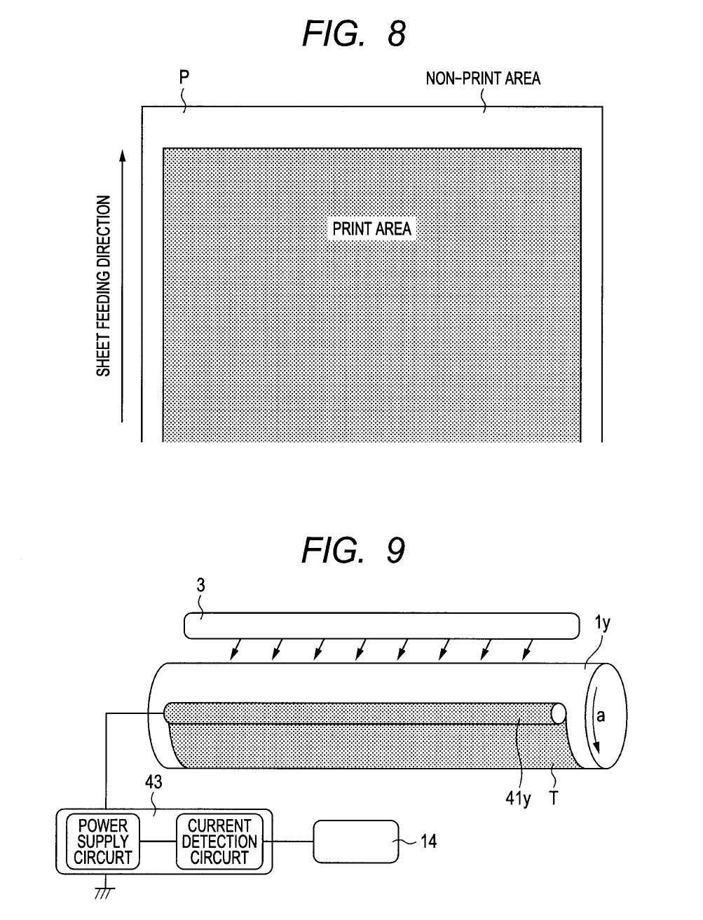

Now, the characteristics of the present embodiment will be specifically described. A method of detecting an electrical resistance of a sheet will be described. The electrical resistance of the sheet is detected by the high-voltage control unit 14 having a measurement unit measuring the electrical resistance of the recording material. FIG. 8 illustrates a sheet resistance detection position.

First, in a state in which there is no sheet in the secondary transfer nip portion, a predetermined secondary transfer voltage U[V] (1 kV in the present embodiment) is applied to measure a current value jₐ. Then, in the state in which a non-print area at a distal end of the sheet illustrated in FIG. 8 is inserted into the secondary transfer nip portion, the same secondary transfer voltage (1 kV in the present embodiment) as at jₐ measurement is applied to measure a current value j_{b}. The above two current values can be used to obtain a resistance value R of a sheet (hereinafter referred to as a sheet resistance) by the following expression.

R=U×(1/j_{b}−1/jₐ)

The value of the sheet resistance R is temporarily stored in the storage apparatus 15.

Further, a reference sheet resistance R₀ (second reference value) used to set control voltage value V_{ff} in embodiment 1 is preliminarily measured and stored in the same procedure. Note that the reference sheet resistance R₀ is measured and set for each atmospheric environment and print mode and then stored in the storage apparatus 15.

At printing, the high-voltage control unit 14 acquires atmospheric environment information from the atmospheric environment detection unit 16 and acquires the control voltage value V_{ff} according to the atmospheric environment and the print mode from the storage apparatus 15. Then, like embodiment 1, the high-voltage control unit performs a correction according to the blank region width y [mm] and further performs a correction based on the sheet resistance R. The correction control voltage value V_{y} to be applied when the blank region has a width of y [mm] is obtained by multiplying the control voltage value obtained in embodiment 1 by a coefficient f according to the sheet resistance R, which may be the following expression.

V_{y}=f×Y(y)×V_{ff}

The present inventors have found, from our studies, that by setting the coefficient f according to the sheet resistance R as shown in the following Table 2, we have successfully obtained a sufficient voltage ΔV regardless of the sheet resistance R and have prevented an occurrence of a transfer failure. The coefficient f is a value specific to a particular device depending on the configuration of the secondary transfer unit such as the resistance of the intermediate transfer belt 5.

Thus, when the sheet resistance R is lower than the second reference value (resistance R₀), the high-voltage control unit 14 corrects the secondary transfer voltage. More specifically, the high-voltage control unit corrects the secondary transfer voltage such that the voltage has the same polarity as the control voltage value V_{ff} and the absolute value is greater than the absolute value of the secondary transfer voltage when the sheet resistance R is equal to or greater than the second reference value (resistance R₀).

TABLE 2

| | RESISTANCE CHANGE | | | | |
|---|---|---|---|---|---|
| | RATIO WITH RESPECT | | | | |
| | TO REFERENCE SHEET | | | | |
| | 0.01 | 0.1 | 1 | 10 | 100 |
| COEFFICIENT f | 2 | 1.5 | 1 | 0.67 | 0.5 |

Note that the sheet resistance R is measured for each print, and the measurement results are maintained up to the end of printing. At the next printing, the sheet resistance R is measured again, and the value of the sheet resistance R is updated and temporarily stored in the storage apparatus 15.

The high-voltage control unit 14 performs a process from acquiring the laser emitting state information to calculating the blank region width y [mm] and to performing a correction based on the electrical resistance of the sheet for each line. The high-voltage control unit 14 calculates the correction control voltage value V_{y} to be applied when the blank region has a width of y [mm] as described above to sequentially correct the control voltage value V_{ff} to the correction control voltage value V_{y} as illustrated in FIG. 7B.

The above configuration has proven that an appropriate voltage ΔV has been applied to the toner layer T regardless of a change in the blank region width y [mm] and the sheet resistance R, thus preventing an occurrence of a transfer failure. Meanwhile, when an image with a small blank region width is printed, an excessively large voltage ΔV is not applied to the toner layer T, thus preventing an occurrence of another image failure such as a reverse transfer due to toner charging polarity reversal.

Note that in the present embodiment, the sheet resistance is also high in an environment other than the high humidity environment. Therefore, the transfer current is unlikely to flow in a direction indicated by an arrow <c> in FIG. 3, namely, from the position of the toner layer T to the blank region without toner. Use of the equivalent circuit reveals that as illustrated in FIG. 5B, the potential at the position A is unlikely to depend on the blank region resistance.

Specifically, any change in blank region width does not reduce the voltage ΔV, and is unlikely to generate a transfer failure. Accordingly, in this case, control can be made with a constant control voltage value regardless of the blank region width. Note that according to the present embodiment, based on an output from the atmospheric environment detection unit 16, when an absolute moisture amount in the atmospheric environment is equal to or greater than 16 [g/m³], a high humidity environment is determined to make correction.

Note also that the present embodiment describes a configuration of acquiring the control voltage value V_{ff} from the storage apparatus 15 based on the output from the atmospheric environment detection unit 16, but is not limited to this. For example, when no sheet is fed, the constant current control is made with a predetermined transfer current value, and based on the result, the control voltage is determined, which is a conventionally well-known configuration, the result of which may be used as the control voltage value V_{ff}. Further, based on the result of the constant current control, the atmospheric environment may be determined.

### Embodiment 3

Embodiment 3 describes that the toner charge characteristics and the toner amount (toner weight per unit area) change in embodiment 1. Note that the configuration and the operation of the image forming apparatus of the present embodiment are the same as those of embodiment 1. Thus, the same reference numerals or characters are assigned to the same components as those of embodiment 1, and the description is omitted.

The optimal transfer voltage fundamentally depends on the state of the toner to be transferred (such as charge amount). For example, consider the case in which the toner charge amount is reduced due to durability degradation and the like. As described in embodiment 1, the following relation is established between the voltage ΔV required for toner transfer and the electric charge amount Q of the toner.

Q=C(capacitance of the toner layer)×ΔV

A reduction in toner charge amount means a reduction in electric charge amount Q of the toner, and thus the voltage ΔV required for toner transfer also reduces.

Thus, for example, when a long time has elapsed since the start of the use, a secondary transfer voltage set to fit the toner charge amount in an initial state causes an excessively large transfer voltage, leading to a concern that a transfer failure occurs. Conversely, at the start of the use, a secondary transfer voltage set to fit the toner charge amount in a state in which a long time has elapsed since the start of the use leads to a concern that an image failure such as a reverse transfer due to toner charging polarity reversal occurs. The change in toner charge amount depends on the use history such as a print image and an image mode, and thus it is difficult to predict the change in toner charge amount.

Further, the optimal transfer voltage depends on the toner amount to be transferred. For example, an increase in toner amount involves an increase in electric charge amount Q of the toner, and thus the voltage ΔV required for toner transfer also increases.

It is an object of the present embodiment to set an optimal transfer voltage for excellent transfer regardless of a change in a toner state (such as charge amount) due to durability degradation.

The present embodiment detects the change in the toner charge amount and the toner amount, and performs a correction according to the detection results. More specifically, when the product of the toner charge amount and the toner amount is determined to increase, a correction is made so as to supply a higher secondary transfer voltage to provide an appropriate potential at the position A, namely, an appropriate voltage ΔV, thus preventing an occurrence of a transfer failure.

Now, the characteristics of the present embodiment will be specifically described.

As described in embodiment 1, since transferring (moving) toner can be considered to be equivalent to charging a capacitor, the following relation is established between the electric charge amount Q of the toner to be moved and the required voltage ΔV.

Q=C(capacitance of the toner layer)×ΔV

Therefore, for example, when the toner charge amount or the toner amount increases and the electric charge amount Q increases to n times, the required voltage ΔV also increases to n times.

The present embodiment detects the change in the toner charge amount and the toner amount by measuring the development current. The potential difference between the development voltage applied to the developing roller and the potential of the exposure unit in the photosensitive member is generally equal to or less than a discharge threshold. Accordingly, a current flowing at development is equivalent to a product of the amount of electric charge movement, namely, the toner charge amount per unit weight and the weight of the moved (developed) toner. Therefore, the change in the toner charge amount and the toner amount can be detected by measuring the development current. Here, the product of the toner charge amount per unit weight and the weight of the moved (developed) toner corresponds to the charge amount of the toner image transferred to the recording material P in the secondary transfer unit.

Referring to FIG. 9, the development current measuring method of the present embodiment will be described.

The development current measuring method can be applied to every color, and thus the description will focus only on yellow. First, an electrostatic latent image with a blank region width of 0 mm is formed on the photosensitive member 1y and is developed by the developing roller 41y. The development current q_{1y} is measured by a current detection circuit in the development high-voltage power supply as a charge amount calculation unit. This measurement is performed during non-printing operation such as when the power is turned on. Note that the development current q_{1y} is temporarily stored in the storage apparatus 15.

Further, in the same procedure, a development current q_{0y} (third reference value) when the control voltage value V_{ff} is set in embodiment 1 is preliminarily measured and stored. The q_{0y} is measured for each atmospheric environment and stored in the storage apparatus 15. Regarding the other colors, in the same procedure, development currents q₀ₘ, q_{0c}, q₀ₖ, q₁ₘ, q_{1c}, and q₁ₖ are measured and stored in the storage apparatus 15. At printing, the high-voltage control unit 14 acquires the values of V_{ff}, R₀, R, q_{0y}, q₀ₘ, q_{0c}, q₀ₖ, q_{1y}, q₁ₘ, q₁ₒ, and q₁ₖ according to the atmospheric environment from the print mode based on the information of the atmospheric environment detection unit 16 and the storage apparatus 15. Then, in the same procedure as in embodiment 2, the present embodiment obtains the correction control voltage value V_{y} to be applied when the blank region has a width of y [mm] and further performs a correction based on the toner state change.

Here, when the development current q_{1y} is greater than the third reference value (development current q_{0y}), the high-voltage control unit 14 corrects the secondary transfer voltage. More specifically, the high-voltage control unit 14 corrects the secondary transfer voltage such that the voltage has the same polarity as the control voltage value V_{ff} and the absolute value is greater than the absolute value of the secondary transfer voltage when the development current q_{1y} is equal to or less than the third reference value (development current q_{0y} or less).

The correction procedure based on the toner state change of the present embodiment will be described.

First, the ratio between the development currents q₀ (q_{0y}, q₀ₘ, q_{0c}, q₀ₖ) and q₁ (q_{1y}, q₁ₘ, q_{1c}, q₁ₖ): q_{y}=q_{1y}/q_{0y}; qₘ=q₁ₘ/q₀ₘ; q_{c}=q_{1c}/q_{0c}; and qₖ=q₁ₖ/q₀ₖ is calculated. These q_{y}, qₘ, q_{c}, and qₖ are used as a toner state change parameter.

Meanwhile, yellow, magenta, cyan, and black toners are mixed in the secondary transfer unit. In general, each toner durability varies and each toner state also varies. Further, toner ratio varies for each image. Therefore, the control value of the secondary transfer voltage cannot be corrected, for example, by the toner state change parameter of only any one of the colors.

In light of this, the present embodiment obtains a weighted average N of the toner state change parameters to correct the control value of the secondary transfer voltage.

Hereinafter, a method of obtaining the weighted average N will be described.

Like embodiment 1, the high-voltage control unit 14 acquires the laser emitting state information about each color: yellow, magenta, cyan, and black in the longitudinal direction as illustrated in FIG. 5A from the controller 17. More specifically, the high-voltage control unit 14 acquires the laser emitting state information about magenta, cyan, and black based on a phase difference according to the distance from the primary transfer unit of yellow to the primary transfer unit of magenta, cyan, and black. In other word, the high-voltage control unit 14 acquires the laser emitting state information at the same position of the final output image.

Based on the laser emitting state information about each color, the high-voltage control unit 14 calculates the total time of the laser emitting areas: T_{y}, Tₘ, T_{c}, and Tₖ [sec] of each color. These T_{y}, Tₘ, T_{c}, and Tₖ [sec] are used to calculate the weighted average N of the toner state change parameters by the following expression.

$$N = \frac{{q}_{y} \times {T}_{y} + {q}_{m} \times {T}_{m} + {q}_{c} \times {T}_{c} + {q}_{k} \times {T}_{k}}{{T}_{y} + {T}_{m} + {T}_{c} + {T}_{k}} \qquad [ Formula 1 ]$$

The correction control voltage value V_{y} of the secondary transfer voltage is corrected using the weighted average N of the toner state change parameters as follows.

V_{y}=N×f×Y(y)×V_{ff}

The above configuration allows the control voltage value of the secondary transfer voltage to be corrected to reflect a larger amount of toner.

The high-voltage control unit 14 performs a process from acquiring the laser emitting state information to calculating the blank region width y [mm] and to performing a correction based on the electrical resistance of the sheet and the toner state change for each line. The high-voltage control unit 14 calculates the correction control voltage value V_{y} to be applied when the blank region has a width of y [mm] as described above to sequentially correct the control voltage value V_{ff} to the correction control voltage value V_{y} as illustrated in FIGS. 7A and 7B.

The above configuration can maintain the voltage ΔV applied to the toner layer T to a value required for toner transfer regardless of a change in the blank region width y [mm], the sheet resistance, and the toner state (charge amount, toner amount, and the like), thus preventing an occurrence of a transfer failure.

Meanwhile, when an image with a small blank region width is printed, an excessively large voltage ΔV is not applied to the toner layer T, thus preventing an occurrence of another image failure such as a reverse transfer due to toner charging polarity reversal.

Note that in the present embodiment, the sheet resistance is also high in an environment other than the high humidity environment. Therefore, the transfer current is unlikely to flow in a direction indicated by an arrow <c> in FIG. 3, namely, from the position of the toner layer T to the blank region without toner. Use of the equivalent circuit reveals that as illustrated in FIG. 5B, the potential at the position A is unlikely to depend on the blank region resistance. Specifically, any change in blank region width does not reduce the voltage ΔV, and is unlikely to generate a transfer failure. Accordingly, in this case, a control can be made with a constant control voltage value regardless of the blank region width.

Note also that the present embodiment describes a configuration of acquiring the control voltage value V_{ff} from the storage apparatus 15 based on the output from the atmospheric environment detection unit 16, but is not limited to this. For example, when no sheet is fed, the constant current control is made with a predetermined transfer current value, and based on the result, the control voltage is determined, which is a conventionally well-known configuration, and the result of which may be used as the control voltage value V_{ff}. Further, based on the results of the constant current control, the atmospheric environment may be determined.

### Embodiment 4

Embodiment 4 describes that the secondary transfer high-voltage power supply 91 is subjected to the constant current control. Note that the configuration and the operation of the image forming apparatus of the present embodiment are the same as those of embodiment 1. Thus, the same reference numerals or characters are assigned to the same components as those of embodiment 1, and the description is omitted. Here, the configuration of the secondary transfer high-voltage power supply 91 of the present embodiment is also the same as that of embodiment 1, but the present embodiment performs the constant current control. In the present embodiment, the secondary transfer high-voltage power supply 91 corresponds to a current supply unit.

Now, the characteristic units in the present embodiment will be described. The problems to be solved and the mechanism for solving the problems in the present embodiment are the same as those in embodiment 1, and thus referring back to FIGS. 3 and 4, the description continues.

When a hygroscopic sheet is used as the recording material in the high humidity environment, the electrical resistance of the sheet is reduced. Accordingly, a transfer current tends to flow in a direction indicated by an arrow <c> in FIG. 3, namely, from the position of the toner layer T to the blank region without toner. As a result, the potential at the position A illustrated in FIG. 3 is lowered. Thus, it is concerned that a potential difference required for toner transfer cannot be obtained and a transfer failure occurs. Further, if there is a large blank region without toner, the potential at the position A is further lowered and thus it is concerned that the transfer failure becomes further remarkable.

Meanwhile, in the case in which the transfer current is increased to prevent an occurrence of a transfer failure occurring when the blank region width is increased, an excessive current occurs when an attempt is made to print an image with a small blank region width. In this case, it is concerned that reverse transfer due to toner charging polarity reversal causes a problem such as an image concentration reduction.

In view of this, it is an object of the present embodiment to prevent an occurrence of a transfer failure and a reverse transfer regardless of the size of the blank region.

As described in embodiment 1 referring to FIGS. 3 and 4, an increase in blank region width reduces the voltage ΔV, and the amount Q of the transferable (movable) electric charge becomes insufficient, leading to a concern that a transfer failure occurs. Meanwhile, in the case in which the transfer voltage is increased to prevent an occurrence of a transfer failure occurring when the blank region width increases, the voltage ΔV becomes excessively large when an attempt is made to print an image with a small blank region width. In this case, it is concerned that reverse transfer due to toner charging polarity reversal causes a problem such as an image concentration reduction.

Accordingly, in order to solve both problems with the transfer failure and the reverse transfer at the same time, the secondary transfer current needs to be corrected according to the blank region width so as to prevent the voltage ΔV from being excessively large or small. Specifically, when the blank region width increases, a higher secondary transfer current needs to be applied.

Referring to FIG. 5A, further consider the case of performing the constant current control.

As described above, an increase in blank region width is equivalent to a parallel circuit of the resistance of the blank region as illustrated in FIG. 5A. In other word, n times the blank region width is equivalent to an n number of parallel circuits of a blank region resistance and hence the blank region resistance is 1/n. Consequently, when the constant current control is made with a constant current value, the potential at the position A becomes 1/n and the value of the voltage ΔV also becomes 1/n, leading to a concern that a transfer failure occurs. Thus, in order to maintain the voltage ΔV to a constant value when the blank region width increases to n times, the value of the current to flow through the blank region needs to increase to n times so as to increase the potential at the position A to n times.

In light of this, the present embodiment detects the blank region width and sequentially corrects the control current value according to the change in blank region width so as to obtain a sufficient voltage ΔV, thereby preventing an occurrence of a transfer failure. More specifically, when the blank region width increases, a correction is made so as to increase the control current value, thereby suppressing a reduction in potential at the position A, namely, a reduction in the voltage ΔV, and thus preventing an occurrence of a transfer failure.

Now, the characteristics of the present embodiment will be specifically described.

First, consider the current flowing through the blank region. When the blank region width changes from the reference y₀ [mm] (10 mm in the present embodiment) to y [mm], the current flowing through the blank regionneeds to be as follows.

(y/y₀)×(blank region current when the blank region width is y₀ [mm])

Here, the blank region current when the blank region width is y₀ [mm] can be obtained in the following procedure.

First, a current value I_{solid} required to transfer an image when the blank region width is 0 [mm] is preliminarily measured. The current value does not contain the value of the current flowing through the blank region, and hence only the current value required to move toner is obtained.

Next, a sheet serving as the reference is used and a control current value I_{ff} (reference current value) is preliminarily set so as to obtain an optimal transferability when the blank region width is y₀ [mm] as the reference (10 mm in the present embodiment). Note that the I_{solid} and I_{ff} are measured and set for each atmospheric environment and print mode and stored in the storage apparatus 15.

At printing, the high-voltage control unit 14 acquires the values of I_{solid} and I_{ff} according to the atmospheric environment and the print mode based on the information of the atmospheric environment detection unit 16 from the storage apparatus 15. Then, the high-voltage control unit 14 obtains the blank region current when the blank region width is y₀ [mm] based on the following expression.

The blank region current when the blank region width is y₀ [mm] is obtained by subtracting the current required to move toner from the control current value I_{ff} by the following expression.

I_{ff}−((L−y₀)/L)×I_{solid}

(L: length in the sheet width direction)

Therefore, the Current to Flow Through the Blank region when the blank region width is y [mm] to maintain a constant voltage ΔV is as follows.

(I_{ff}−((L−y₀)/L)×I_{solid})×y/y₀

Next, consider the current value required to move toner.

Obviously, a change in blank region width accordingly involves a change in toner portion width. When the toner portion width changes to 1/m, the electric charge amount Q of the toner to be moved also changes to 1/m and hence the current value required to move toner also changes to 1/m. Accordingly, the current value required to move toner when the blank region width is y [mm] is obtained by multiplying the ratio between the toner portion width and a sheet width L by the current value when the toner portion width is the sheet width L in the sheet width direction, namely, the current value I_{solid} when the blank region width is 0 [mm] as follows.

((L−y)/L)×I_{solid}

Thus, the correction control current value I_{y} when the blank region width is y [mm] is obtained by adding the blank region current and the current required to move toner (electric charge) by the following expression.

$$\begin{matrix}( Expression 1 ) & \\ {I}_{y} = \frac{L - y}{L} \times {I}_{solid} + \frac{y}{{y}_{0}} \times ( {I}_{ff} - \frac{L - {y}_{0}}{L} \times {I}_{solid} ) & [ Formula 2 ]\end{matrix}$$

The method of obtaining the blank region width y [mm] is the same as that described in embodiment 1, and the description thereof is omitted.

The high-voltage control unit 14 performs a process from acquiring the laser emitting state information to calculating the blank region width y [mm] for each line. The high-voltage control unit 14 calculates the correction control current value I_{y} based on the above expression (1) to sequentially correct the control current value I_{ff} to the correction control current value I_{y} as illustrated in FIGS. 7A and 7B.

Thus, according to the present embodiment, the high-voltage control unit 14 corrects the secondary transfer current (constant current control value) when the toner image is transferred to the recording material in the secondary transfer unit, and the total length of the blank region without the toner image is larger than the first reference value (y₀ [mm]). More specifically, the high-voltage control unit 14 corrects the secondary transfer current such that the current has the same polarity as the preset control current value I_{ff} corresponding to the first reference value, and the absolute value is greater than the absolute value of the control current value I_{ff}.

The above configuration has proven that an appropriate voltage ΔV has been applied to the toner layer T regardless of a change in blank region width, thus preventing an occurrence of a transfer failure. Meanwhile, when an image with a small blank region width is printed, an excessively large voltage ΔV is not applied to the toner layer T, thus preventing an occurrence of another image failure such as a reverse transfer due to toner charging polarity reversal.

Note that in the present embodiment, the sheet resistance is also high in an environment other than the high humidity environment. Therefore, the transfer current is unlikely to flow in a direction indicated by an arrow <c> in FIG. 3, namely, from the position of the toner layer T to the blank region without toner. Use of the equivalent circuit reveals that as illustrated in FIG. 5B, the potential at the position A is unlikely to depend on the blank region resistance.

Specifically, any change in blank region width does not reduce the voltage ΔV, and is unlikely to generate a transfer failure. Accordingly, in this case, a control can be made with a constant control current value regardless of the blank region width. Note that according to the present embodiment, based on an output from the atmospheric environment detection unit 16, when an absolute moisture amount in the atmospheric environment is equal to or greater than 16 [g/m³], a high humidity environment is determined to make correction.

### Embodiment 5

Like embodiment 4, embodiment 5 describes that the secondary transfer high-voltage power supply 91 is subjected to the constant current control. Note that the configuration and the operation of the image forming apparatus of the present embodiment are the same as those of embodiments 1, 2, and 4. Thus, the same reference numerals or characters are assigned to the same components as those of embodiments 1, 2, and 4, and the description is omitted. Here, the configuration of the secondary transfer high-voltage power supply 91 of the present embodiment is also the same as that of embodiment 1, but the present embodiment performs the constant current control.

As described in embodiment 2, various types of recording materials of varying characteristics are available on the market. The electrical resistance is one of the characteristics. The electrical resistance of the sheet in the high humidity environment is generally different depending on the type of the sheet.

In light of this, it is an object of the present embodiment to prevent an occurrence of a transfer failure and an image failure such as a reverse transfer due to toner charging polarity reversal regardless of the change in resistance of recording material.

As described in embodiment 2, in order to sufficiently move (transfer) toner, a voltage ΔV according to the electric charge of the toner needs to be applied to the toner layer T. The value of the voltage ΔV is determined by the resistance value of the blank region and the value of the current flowing therethrough. As understood from FIG. 3, the potential at the position A changes according to the product of the voltage drop in the sheet portion, namely, the sheet resistance and the current flowing through the sheet. For example, consider a case in which when the sheet resistance reduces, a control is made with the control current value obtained in embodiment 4. Then, the potential at the position A is lower than that of the reference sheet and the voltage ΔV becomes insufficient, leading to a concern that a transfer failure occurs. Conversely, when the sheet resistance is higher than that of the reference sheet, the potential at the position A is higher than that of the reference sheet and the voltage ΔV becomes excessively large, leading to a concern that another image failure such as reverse transfer due to toner charging polarity reversal occurs.

Therefore, in order to solve this problem, the control current value needs to be corrected according to the change in sheet resistance. In light of this, the present embodiment not only corrects the control current value I_{ff} according to the change in the blank region width as described in embodiment 4, but also detects the sheet resistance and performs correction according to the detection results. More specifically, when the sheet resistance is determined low, a correction is made so as to apply a larger secondary transfer current.

Now, the characteristics of the present embodiment will be specifically described.

The method of detecting the sheet resistance is the same as described in embodiment 2, and the description is omitted. In the same manner as in embodiment 2, the value of the sheet resistance R is temporarily stored in the storage apparatus 15; and the reference sheet resistance R₀ is measured and set for each atmospheric environment and print mode and stored in the storage apparatus 15.

At printing, the high-voltage control unit 14 acquires the values of I_{solid}, I_{ff}, R₀, and R according to the atmospheric environment and the print mode based on the information of the atmospheric environment detection unit from the storage apparatus 15. Then, in the same procedure as in embodiment 4, the high-voltage control unit 14 obtains the blank region current when the blank region width is y₀ [mm]. Subsequently, the high-voltage control unit 14 further makes a correction based on the sheet resistance to determine the current to flow through the blank region.

The current to flow through the blank region when the blank region has a width of y [mm] can be obtained by multiplying the blank region current obtained in embodiment 4 by a coefficient g according to the sheet resistance. Thus, the current value flowing through the blank region may be obtained by the following expression.

g×(I_{ff}−((L−y₀)/L)×I_{solid})×y/y₀

The present inventors have found, from our studies, that by setting the coefficient f according to the sheet resistance as shown in Table 3, we have successfully obtained a sufficient voltage ΔV regardless of the sheet resistance and have prevented an occurrence of a transfer failure. The coefficient f is a value specific to a particular device depending on the configuration of the secondary transfer unit such as the resistance of the intermediate transfer belt 5.

Thus, the high-voltage control unit 14 corrects the secondary transfer current (constant current control value) when the sheet resistance R is less than the second reference value (resistance R₀). More specifically, the high-voltage control unit 14 corrects the secondary transfer current such that the current has the same polarity as the control current value I_{ff} and the absolute value is greater than the absolute value of the secondary transfer current when the sheet resistance R is equal to or greater than the second reference value (resistance R₀).

TABLE 3

| | RESISTANCE RATIO WITH | | | | |
|---|---|---|---|---|---|
| | RESPECT TO REFERENCE | | | | |
| | SHEET (R/R₀) | | | | |
| | 0.01 | 0.1 | 1 | 10 | 100 |
| COEFFICIENT g | 10 | 5 | 1 | 0.5 | 0.1 |

Meanwhile, the current required to move toner is not affected by the sheet resistance and hence is the same as that in embodiment 4. Thus, the correction control current value I_{y} when the blank region width is y [mm] can be obtained by adding the blank region current to the current of toner (electric charge) movement by the following expression.

$$\begin{matrix}( Expression 2 ) & \\ {I}_{y} = \frac{L - y}{L} \times {I}_{solid} + g \times \frac{y}{{y}_{0}} \times ( {I}_{ff} - \frac{L - {y}_{0}}{L} \times {I}_{solid} ) & [ Formula 3 ]\end{matrix}$$

Note that the sheet resistance R is measured for each print, and the measurement results are maintained up to the end of printing. At the next printing, the sheet resistance R is measured again, and the value of the sheet resistance R is updated and temporarily stored in the storage apparatus 15.

The high-voltage control unit 14 performs a process from acquiring the laser emitting state information to calculating the blank region width y [mm] and to performing a correction based on the electrical resistance of the sheet for each line. The high-voltage control unit 14 calculates the correction control current value I_{y} when the blank region width is y [mm] based on the above expression (2) to sequentially correct the control current value I_{ff} to the correction control current value I_{y} as illustrated in FIG. 7B.

The above configuration has proven that an appropriate voltage ΔV has been applied to the toner layer T regardless of a change in the blank region width y [mm] and the sheet resistance, thus preventing an occurrence of a transfer failure. Meanwhile, when an image with a small blank region width is printed, an excessively large voltage ΔV is not applied to the toner layer T, thus preventing an occurrence of another image failure such as a reverse transfer due to toner charging polarity reversal.

Note that in the present embodiment, the sheet resistance is also high in an environment other than the high humidity environment. Therefore, the transfer current is unlikely to flow in a direction indicated by an arrow <c> in FIG. 3, namely, from the position of the toner layer T to the blank region without toner. Use of the equivalent circuit reveals that as illustrated in FIG. 5B, the potential at the position A is unlikely to depend on the blank region resistance.

Specifically, any change in blank region width does not reduce the voltage ΔV, and is unlikely to generate a transfer failure. Accordingly, in this case, control can be made with a constant control current value regardless of the blank region width. Note that according to the present embodiment, based on an output from the atmospheric environment detection unit 16, when an absolute moisture amount in the atmospheric environment is equal to or greater than 16 [g/m³], a high humidity environment is determined to make correction.

### Embodiment 6

Embodiment 6 also describes that the secondary transfer high-voltage power supply 91 is subjected to the constant current control. Note that the configuration and the operation of the image forming apparatus of the present embodiment are the same as those of embodiments 1, 3, and 4. Thus, the same reference numerals or characters are assigned to the same components as those of embodiments 1, 3, and 4, and the description is omitted. Here, the configuration of the secondary transfer high-voltage power supply 91 of the present embodiment is also the same as that of embodiment 1, but the present embodiment performs the constant current control.

Like embodiment 3, the optimal secondary transfer current values depend on the toner amount and the charging state of the toner to be transferred. In light of this, it is an object of the present embodiment to set an optimal secondary transfer current value for excellent transfer regardless of a change in a toner state (such as charge amount) due to durability degradation and the like.

As described in embodiment 1, since transferring (moving) toner can be considered to be equivalent to charging a capacitor, the following relation is established between the electric charge amount Q of the toner to be moved and the required voltage ΔV.

Q=C(capacitance of the toner layer)×ΔV

Therefore, for example, when the toner charge amount or the toner amount increases and the electric charge amount Q of the toner increases to z times, the required voltage ΔV also increases to z times. Thus, as understood from FIG. 3, the value of the current to flow through the blank region needs to increase to z times. At the same time, the electric charge amount of the toner to be moved increases, and hence the current value of the toner movement increase to z times.

In light of this, like embodiment 3, the present embodiment detects the change in the toner charge amount and the toner amount, and performs a correction according to the detection results. More specifically, when the toner charge amount and the toner amount are determined to increase, a correction is made so as to supply a higher secondary transfer current.

Now, the characteristics of the present embodiment will be specifically described.

The method of obtaining the weighted average N of the toner state change parameters is the same as in embodiment 3, and the description is omitted.

At printing, the high-voltage control unit 14 acquires the values of I_{solid}, I_{ff}, R₀, and R according to the atmospheric environment and the print mode based on the information of the atmospheric environment detection unit from the storage apparatus 15. Then, in the same procedure as in embodiment 4, the high-voltage control unit 14 obtains the blank region current when the blank region width is y₀ [mm]. Subsequently, the high-voltage control unit 14 corrects the correction control current value I_{y} of the secondary transfer current using the weighted average N of the toner state change parameters obtained in the same manner as in embodiment 3.

First, consider the current value required to move toner. As described above, since the product of the toner charge amount and the toner amount increases to N times, the current value required to move toner also increases to N times. Thus, the current value required to move toner is as follows.

N×((L−y)/L)×I_{solid}

Next, consider the value of the current flowing through the blank region. The product of the toner charge amount and the toner amount increases to N times, the value of the voltage ΔV required for toner transfer also increases to N times as described above. In order to increase the value of the voltage ΔV to N times, a correction may be made to increase the value of the current to flow through the blank region to N times. Thus, the value of the current to flow through the blank region is as follows.

N×g×(I_{ff}−((L−y₀)/L)×I_{solid})

Therefore, the correction control current value I_{y} of the secondary transfer current is obtained by adding the value of the current required to move toner and the value of the current to flow through the blank region as the following expression.

$$\begin{matrix} ( Expression 3 ) & \\ {I}_{y} = N \times \{ \frac{L - y}{L} \times {I}_{solid} + g \times \frac{y}{{y}_{0}} \times ( {I}_{ff} - \frac{L - {y}_{0}}{L} \times {I}_{solid} ) \} & [ Formula 4 ]\end{matrix}$$

The above configuration allows the control current value of the secondary transfer current to be corrected to reflect a larger amount of toner.

The high-voltage control unit 14 performs a process from acquiring the laser emitting state information to calculating the blank region width y [mm] and to performing a correction based on the electrical resistance of the sheet and the toner state change for each line. The high-voltage control unit 14 calculates the correction control current value I_{y} to be applied when the blank region has a width of y [mm] based on the above expression (3) to sequentially correct the control current value I_{ff} as illustrated in FIGS. 7A and 7B. Thus, the high-voltage control unit 14 corrects the secondary transfer current when the development current q_{1y} is greater than the third reference value (development current q_{0y}). More specifically, the high-voltage control unit 14 corrects the secondary transfer current such that the current has the same polarity as the control current value I_{ff} and the absolute value is greater than the absolute value of the secondary transfer current when the development current q_{1y} is equal to or less than the third reference value (development current q_{0y}).

The above configuration can maintain the voltage ΔV applied to the toner layer T to a value required for toner transfer regardless of a change in the blank region width y [mm], the sheet resistance, and the toner state (charge amount, toner amount, and the like), thus preventing an occurrence of a transfer failure. Meanwhile, when an image with a small blank region width is printed, an excessively large voltage ΔV is not applied to the toner layer T, thus preventing an occurrence of another image failure such as a reverse transfer due to toner charging polarity reversal.

Here, above embodiments 1 to 6 have described that the toner image is transferred to the recording material P in the secondary transfer unit located between the intermediate transfer belt 5 and the secondary transfer roller 9, but the present invention is not limited to these embodiments. Specifically, the present invention may be suitably applied to other cases in which the toner image is transferred to the recording material P in a transfer unit of other embodiments. Examples of other embodiments include a case in which the toner image is transferred to the recording material P in a nip portion located between the photosensitive member as an image bearing member and the transfer conveyor belt as a transfer member in the direct transfer system. Further, another example thereof is such that the toner image is transferred to the recording material P in a nip portion located between the photosensitive member and a transfer roller as the transfer member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-205984, filed Sep. 14, 2010, which is hereby incorporated by reference herein in its entirety.

What is claimed is:

1. An image forming apparatus comprising:
an image bearing member on which a toner image is formed;
a transfer member that forms a nip portion with the image bearing member therebetween, wherein the transfer member transfers the toner image formed on the image bearing member to a recording material;
a calculation unit that calculates a total length of a blank region in which toner is not moved with respect to the length of the recording material in a direction perpendicular to the direction of conveying the recording material
before the toner image on the image bearing member is transferred to the recording material in the nip portion;
a voltage supply unit supplying a voltage to the transfer member so as to transfer the toner image to the recording material; and
a control unit that controls the voltage supply unit, wherein in a case where the total length of the blank region calculated by the calculation unit is greater than a preset first reference value, the control unit corrects a voltage supplied from the voltage supply unit to the transfer member so that the voltage has the same polarity as a preset reference voltage corresponding to the first reference value and an absolute value thereof is greater than the absolute value of the reference voltage.

2. An image forming apparatus according to claim 1, further comprising a measurement unit that measures an electrical resistance value of the recording material, wherein in a case where the electrical resistance value of the recording material measured by the measurement unit is less than a preset second reference value, the control unit corrects the voltage to be supplied from the voltage supply unit to the transfer member such that the voltage has the same polarity as the reference voltage and the absolute value is greater than the absolute value of the voltage to be supplied from the voltage supply unit to the transfer member when the electrical resistance value of the recording material is equal to or greater than the second reference value.

3. An image forming apparatus according to claim 1, further comprising a charge amount calculation unit that calculates a charge amount of the toner image transferred to the recording material in the nip portion, wherein when the charge amount of the toner image calculated by the charge amount calculation unit is greater than a preset third reference value, the control unit corrects the voltage to be supplied from the voltage supply unit to the transfer member so that the voltage has the same polarity as the reference voltage and the absolute value is greater than the absolute value of the voltage to be supplied from the voltage supply unit to the transfer member when the charge amount of the toner image transferred to the recording material in the nip portion is equal to or less than the third reference value.

4. An image forming apparatus according to claim 1, further comprising a humidity detection unit that detects a humidity in an environment in which the image forming apparatus is installed, wherein
the control unit corrects the voltage to be supplied from the voltage supply unit to the transfer member when the humidity detected by the humidity detection unit is equal to or greater than a preset humidity.

5. An image forming apparatus comprising:
an image bearing member on which a toner image is formed;
a transfer member that forms a nip portion with the image bearing member therebetween, wherein the transfer member transfers the toner image formed on the image bearing member to a recording material
a calculation unit that calculates a total length of a blank region in which toner is not moved with respect to the length of the recording material in a direction perpendicular to the direction of conveying the recording material;
a current supply unit that supplies a current to the transfer member so as to transfer the toner image to the recording material; and
a control unit that performs constant current control on a current supplied from the current supply unit to the transfer member, wherein in a case where the total length of the blank region calculated by the calculation unit is greater than a preset first reference value, the control unit corrects a constant current control value supplied from the current supply unit to the transfer member such that the current has the same polarity as a preset reference current value corresponding to the first reference value and an absolute value thereof is greater than the absolute value of the reference current value.

6. An image forming apparatus according to claim 5, further comprising a measurement unit that measures an electrical resistance value of the recording material wherein in a case where the electrical resistance value of the recording material measured by the measurement unit is less than a preset second reference value, the control unit corrects the constant current control value supplied from the current supply unit to the transfer member so that the current has the same polarity as the reference current value and the absolute value is greater than the absolute value of the constant current control value supplied from the current supply unit to the transfer member when the electrical resistance value of the recording material is equal to or greater than the second reference value.

7. An image forming apparatus according to claim 5, further comprising a charge amount calculation unit that calculates a charge amount of the toner image transferred to the recording material in the nip portion, wherein when the charge amount of the toner image calculated by the charge amount calculation unit is greater than a preset third reference value, the control unit corrects the constant current control value supplied from the current supply unit to the transfer member such that the current has the same polarity as the reference current value and the absolute value is greater than the absolute value of the constant current control value supplied from the current supply unit to the transfer member when the charge amount of the toner image transferred to the recording material in the nip portion is equal to or less than the third reference value.

8. An image forming apparatus according to claim 5, further comprising a humidity detection unit that detects a humidity in an environment in which the image forming apparatus is installed, wherein the control unit corrects the constant current control value supplied from the current supply unit to the transfer member when the humidity detected by the humidity detection unit is equal to or greater than a preset humidity.
